(19) United States
(12) Patent Application Publication
(10) Pub. No.: US 2017/0114175 A1
(43) Pub. Date: Apr. 27, 2017

(54) HETEROGENEOUS CATALYST AND METHOD FOR SELECTIVELY HYDROGENATING COPOLYMER

(71) Applicant: INDUSTRIAL TECHNOLOGY RESEARCH INSTITUTE, Hsinchu (TW)

(72) Inventor: Man-Yin LO, Zhubei City (TW)

(73) Assignee: INDUSTRIAL TECHNOLOGY RESEARCH INSTITUTE, Hsinchu (TW)

(21) Appl. No.: 15/202,819

(22) Filed: Jul. 6, 2016

(30) Foreign Application Priority Data
Oct. 22, 2015 (TW) 104134635

(51) Int. Cl. C08F 299/02; B01J 35/00; B01J 21/04; B01J 23/10; B01J 23/44; B01J 21/08

(52) U.S. Cl. CPC C08F 299/022; B01J 23/44; B01J 21/08; B01J 21/04; B01J 23/10; B01J 35/0006; C08F 2810/00; C08F 2410/01

(57) ABSTRACT

A heterogeneous catalyst for selectively hydrogenating a copolymer is provided, which includes a porous support, a metal oxide wrapping a part of the surface of the porous support, and a plurality of palladium particles on the porous support and the metal oxide. A method for selectively hydrogenating a copolymer is also provided, which includes contacting a heterogeneous catalyst to a copolymer to process hydrogenation. The copolymer includes aromatic rings and nonaromatic double bonds, and the nonaromatic double bonds are hydrogenated, and the aromatic rings are substantially not hydrogenated. The heterogeneous catalyst includes a porous support, a metal oxide wrapping a part of the surface of the porous support, and a plurality of palladium particles formed on the porous support and the metal oxide.

### CROSS REFERENCE TO RELATED APPLICATIONS

The present application is based on, and claims priority from, Taiwan Application Serial Number 104134635, filed on Oct. 22, 2015, the disclosure of which is hereby incorporated by reference herein in its entirety.

### TECHNICAL FIELD

The technical field relates to a hydrogenation of copolymer, and in particular it relates to a heterogeneous catalyst and method for selectively hydrogenating the nonaromatic double bonds of the copolymer and substantially not hydrogenating the aromatic rings of the copolymer.

### BACKGROUND

SBS and SIS belong to a styrene-based thermoplastic elastomer (also named styrenic block copolymers, SBCs) with properties of thermoplastics and rubbers. The SBCs behave like rubber at room temperature due to their softness, toughness, and flexibility. Furthermore, the SBCs behave as plastic at high temperature, which are flowable and moldable. As with natural rubber and synthetic rubber, the SBCs are classified as a third-generation rubber. In the thermoplastic elastomer field, the SBCs' properties are mostly similar to that of rubber. In addition, SBCs consume the largest-volume market within the thermoplastic elastomers family. There are four types of SBCs: styrene-butadiene-styrene block copolymers (SBS), styrene-isoprene-styrene block copolymers (SIS), styrene-ethylene-butylene-styrene block copolymers (SEBS), and styrene-ethylene-propylene-styrene block copolymers (SEPS). The SEBS and the SEPS are hydrogenated form of SBS and SIS, respectively. The SEBS and the SEPS possess excellent properties and have higher price (2 to 4 times) than that of the SBS and the SIS. SBS is the leading product segment of SBCs which accounted for more than 76% of the world market. Furthermore, SBS is also the lowest cost of the most widely used product among the four SBCs. SBS is a triblock copolymer of styrene and butadiene with butadiene mid-blocks. SBS possesses both plastic and rubber properties, and is in largest demand thermoplastic elastomer due to its excellent chemical resistance, excellent tensile strength, high surface friction coefficient, excellent low temperature properties, excellent electrical properties, and excellent processability.

The polybutadiene segment of the SBS and the isoprene-polyisoprene segment of the SIS include carbon-carbon double bonds. As such, the SBS and SIS have disadvantages such as low thermal resistance and low climate resistance (e.g. ozone resistance, UV resistance, and oxygen resistance). These disadvantages can be overcome by hydrogenating the carbon-carbon double bonds of the polybutadiene segment and the isoprene-polyisoprene segment into saturated forms, thereby forming the SEBS (see Formula 1) and the SEPS (see Formula 2), respectively. The hydrogenated products SEBS and SEPS can be applied as engineering and medical materials due to better climate resistance and other properties.

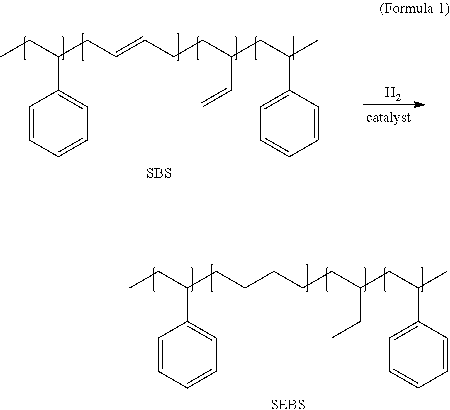

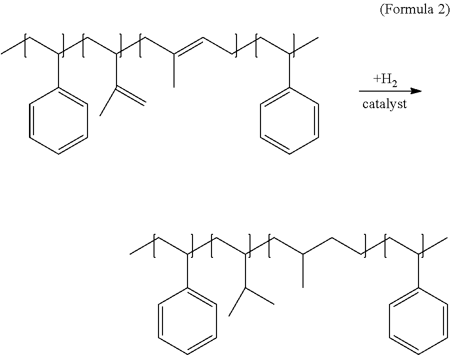

Accordingly, a novel method and corresponding catalyst for forming the SEBS and the SEPS is called for, e.g. selectively hydrogenating the nonaromatic carbon-carbon double bonding of the SBS and the SIS without hydrogenating the aromatic ring of the SBS and the SIS.

### SUMMARY

One embodiment of the disclosure provides a heterogeneous catalyst for selectively hydrogenating a copolymer, including a porous support, a metal oxide wrapping a part of the surface of the porous support, and a plurality of palladium particles on the porous support and the metal oxide. The porous support has a pore diameter between 0.02 μm to 1.2 μm and the palladium particles have a diameter between 1 nm to 3 nm.

One embodiment of the disclosure provides a method for selectively hydrogenating a copolymer, which includes: providing a copolymer with aromatic rings and nonaromatic double bonds, contacting the copolymer to a heterogeneous catalyst, and introducing hydrogen to selectively hydrogenate the nonaromatic double bonds of the copolymer and substantially not hydrogenate the aromatic rings of the copolymer. The heterogeneous catalyst includes a porous support, a metal oxide wrapping a part of the surface of the porous support, and a plurality of palladium particles formed on the porous support and the metal oxide.

A detailed description is given in the following embodiments.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details.

One embodiment of the disclosure provides a method for selectively hydrogenating a copolymer. First, providing a copolymer including aromatic rings and nonaromatic double bonds. The copolymer can be polymerized from polyenic monomer and vinyl aromatic monomer. The polyenic monomer can be butadiene, isoprene, other monomers having at least two carbon-carbon double bonds, or a combination thereof. The vinyl aromatic monomer can be styrene, α-methylstyrene, other vinyl aromatic monomers, or a combination thereof. The copolymer includes aromatic rings and nonaromatic double bonds, such as the SBS (copolymerized of styrene and butadiene) or the SIS (polymerized of styrene and isoprene). In one embodiment, the copolymer has an average molecular weight between 30,000 to 400,000. The average molecular weight range of the copolymer is dependent on products or applications.

Then, the copolymer is put into contact with a heterogeneous catalyst, and hydrogen is introduced to selectively hydrogenate the nonaromatic double bonds of the copolymer and substantially not hydrogenate the aromatic rings of the copolymer. The heterogeneous catalyst comprises a porous support, a metal oxide wrapping a part of the surface of the porous support, and a plurality of palladium particles formed on the porous support and the metal oxide. In one embodiment, the porous support has an average pore diameter between 0.02 μm to 1.2 μm. If the pore diameter of the porous support is too small, it is difficult for the copolymer to get into the pores of the porous support to contact the palladium particles, thereby reducing the hydrogenation yield. If the pore diameter of the porous support is too large, the specific surface area of the porous support is too small to bear a sufficient amount of palladium particles on the porous support. In one embodiment, the palladium particles have a diameter between 1 nm to 3 nm. When the particle diameter of the palladium is too large, the specific surface area of the palladium particles is too small, thereby the catalytic activity is reduced.

In one embodiment, the porous support may be made of titanium oxide, aluminum oxide, zirconium oxide, or silicon oxide. The metal oxide may be samarium oxide (Sm₂O₃), lanthanum oxide (La₂O₃), neodymium oxide (Nd₂O₃) or a combination thereof. In one embodiment, the porous support and the metal oxide have a weight ratio of 1:1 to 1:0.025. When the weight ratio of the metal oxides is too low, it may not effectively prevent aggregation of palladium particles. When the weight ratio of the metal oxides is too high, it may block the copolymer from entering the porous support to contact the palladium particles. In one embodiment, palladium particles have a range of 0.1 wt % to 5 wt % of the catalyst. A catalyst with an overly low amount of palladium particle has low activity, thereby reducing the hydrogenation yield. A catalyst with an overly high amount of palladium particle has a high cost, thereby lacking economic benefits.

In one embodiment, the method for forming the heterogeneous catalyst is provided. For example, an appropriate amount of metal salt was dissolved in water and an appropriate amount of porous support was added to the solution with constant stirring, and then the mixture was vacuum dried in the oven at 110° C. to remove water whereby the metal salts were adsorbed on porous support, and then further sintered at a high temperature to obtain a dried powder with a metal oxide wrapping a part of the surface of the porous support. A palladium salt is dissolved in water, and the dried powder with a metal oxide wrapping a part of the surface of the porous support is soaked in the aqueous solution, and the water thereof is then removed by heating, and then the palladium particles are formed on the porous support and the metal oxide.

In one embodiment, hydrogenation is performed at a temperature of 40° C. to 150° C. under a hydrogen pressure of 10 kg/cm² to 50 kg/cm². In another embodiment, hydrogenation is performed at a temperature of 70° C. to 120° C. under a hydrogen pressure of 30 kg/cm² to 40 kg/cm². Hydrogenation cannot be performed at an overly low temperature and/or under an overly low hydrogen pressure. Hydrogenation not only hydrogenates the nonaromatic double bonds of the copolymer, but also hydrogenates the aromatic rings of the copolymer at an overly high temperature and/or under an overly high hydrogen pressure.

Accordingly, the disclosed heterogeneous catalyst may selectively hydrogenate the nonaromatic double bonds of the copolymer, and substantially not hydrogenate the aromatic rings of the copolymer. For example, only less than 5% of the aromatic rings in the copolymer are hydrogenated, but more than 97% of the nonaromatic double bonds in the copolymer are hydrogenated.

Below, exemplary embodiments will be described in detail with reference to the accompanying drawings so as to be easily realized by a person having ordinary knowledge in the art. The inventive concept may be embodied in various forms without being limited to the exemplary embodiments set forth herein. Descriptions of well-known parts are omitted for clarity, and like reference numerals refer to like elements throughout.

### EXAMPLES

### Preparation Example 1

9.55 g of SiO₂ (Q50, commercially available from Fuji silysia) serving as a porous support was put into an oven at 110° C. to be dried overnight, and then put into a round bottom bottle. 0.735 g of H₂PtCl₆ and 0.155 g of IrCl₃ were dissolved in water to obtain metal salts solution. The solution was added to the round bottom bottle and stood for 2 hours, whereby the metal salts were adsorbed on SiO₂ porous support. The mixture in the round bottom bottle was heated to 110° C. and vacuumed to remove the water thereof to obtain a dried powder. The dried powder was put into a glass tube, 2 vol % of hydrogen was then conducted through the glass tube, and the dried powder was heated to 200° C. and kept at 200° C. for 4 hours to obtain a chemically reduced powder. The heated powder was cooled to room temperature, and air was then conducted through the glass tube to passivate the catalyst surface. Therefore, a Pt_{3.5}Ir₁/SiO₂ catalyst was obtained.

### Preparation Example 2

9.55 g of Al₂O₃ (SD alumina, commercially available from Norpro) serving as a porous support was put into an oven at 110° C. to be dried overnight, and then put into a round bottom bottle. 0.411 g of palladium acetate was dissolved in water to obtain metal salts solution. The solution was added to the round bottom bottle and stood for 2 hours, whereby the metal salts were adsorbed on Al₂O₃ porous support. The mixture in the round bottom bottle was heated to 110° C. and vacuumed to remove the water thereof to obtain a dried powder, Pd₂/Al₂O₃ catalyst.

### Preparation Example 3

9.55 g of Al₂O₃ (44693, commercially available from Alfa) serving as a porous support was put into an oven at 110° C. to be dried overnight, and then put into a round bottom bottle. 0.411 g of palladium acetate was dissolved in water to obtain metal salts solution. The solution was added to the round bottom bottle and stood for 2 hours, whereby the metal salts were adsorbed on Al₂O₃ porous support. The mixture in the round bottom bottle was vacuum dried in the oven at 110° C. to remove the water thereof and a dried powder, Pd₂/Al₂O₃ catalyst was obtained.

### Preparation Example 4

2.524 g of Sm(NO₃)₃ was dissolved in water to obtain an aqueous solution. The aqueous solution and 7.92 g of Al₂O₃ (SD alumina) were added to a round bottom bottle and stirred. The mixture in the round bottom bottle was heated to 110° C. and vacuumed to remove water, and then calcination at 600° C. thereof to obtain a dried powder, 20 wt % Sm₂O₃-alumina. 9.9 g of 20 wt % Sm₂O₃-alumina serving as a porous support was put into an oven at 110° C. to be dried overnight and then put into a round bottom bottle. 0.213 g of palladium acetate was dissolved in water to obtain metal salts solution. The solution was added to the round bottom bottle and stood for 2 hours, whereby the metal salts were adsorbed on 20 wt % Sm₂O₃-alumina porous support. The mixture in the round bottom bottle was heated to 110° C. and vacuumed to remove the water thereof to obtain a dried powder, Pd₁/20 wt % Sm₂O₃-alumina catalyst.

### Preparation Example 5

9.984 g of 20 wt % Sm₂O₃-alumina serving as a porous support was put into an oven at 110° C. to be dried overnight, and then put into a round bottom bottle. 0.034 g of palladium acetate was dissolved in water to obtain metal salts solution. The solution was added to the round bottom bottle and stood for 2 hours, whereby the metal salts were adsorbed on 20 wt % Sm₂O₃-alumina porous support. The mixture in the round bottom bottle was heated to 110° C. and vacuumed to remove the water thereof to obtain a dried powder, Pd_{0.16}/20 wt % Sm₂O₃-alumina catalyst.

### Preparation Example 6

1.271 g of Sm(NO₃)₃ was dissolved in water to obtain an aqueous solution. The aqueous solution and 8.973 g of Al₂O₃ (SD alumina) were added to a round bottom bottle and stirred. The mixture in the round bottom bottle was heated to 110° C. and vacuumed to remove water, and then sintered at 600° C. thereof to obtain a dried powder, 10 wt % Sm₂O₃-alumina. 9.97 g of 10 wt % Sm₂O₃-alumina serving as a porous support was put into an oven at 110° C. to be dried overnight and then put into a round bottom bottle. 0.063 g of palladium acetate was dissolved in water to obtain metal salts solution. The solution was added to the round bottom bottle and stood for 2 hours, whereby the metal salts were adsorbed on 10 wt % Sm₂O₃-alumina porous support. The mixture in the round bottom bottle was heated to 110° C. and vacuumed to remove the water thereof to obtain a dried powder, Pd_{0.3}/10 wt % Sm₂O₃-alumina catalyst.

### Preparation Example 7

0.636 g of Sm(NO₃)₃ was dissolved in water to obtain an aqueous solution. The aqueous solution and 8.973 g of Al₂O₃ (SD alumina) were added to a round bottom bottle and stirred. The mixture in the round bottom bottle was heated to 110° C. and vacuumed to remove water, and then sintered at 600° C. thereof to obtain a dried powder, 5 wt % Sm₂O₃-alumina. 9.9 g of 5 wt % Sm₂O₃-alumina serving as a porous support was put into an oven at 110° C. to be dried overnight and then put into a round bottom bottle. 0.213 g of palladium acetate was dissolved in water to obtain metal salts solution. The solution was added to the round bottom bottle and stood for 2 hours, whereby the metal salts were adsorbed on 5 wt % Sm₂O₃-alumina porous support. The mixture in the round bottom bottle was heated to 110° C. and vacuumed to remove the water thereof to obtain a dried powder, Pd₁/5 wt % Sm₂O₃-alumina catalyst.

### Preparation Example 8

2.922 g of Nd(NO₃)₃ was dissolved in water to obtain an aqueous solution. The aqueous solution and 8.973 g of Al₂O₃ (SD alumina) were added to a round bottom bottle and stirred. The mixture in the round bottom bottle was heated to 110° C. and vacuumed to remove water, and then sintered at 600° C. thereof to obtain a dried powder, 20 wt % Nd₂O₃-alumina. 9.97 g of 20 wt % Nd₂O₃-alumina serving as a porous support was put into an oven at 110° C. to be dried overnight and then put into a round bottom bottle. 0.213 g of palladium acetate was dissolved in water to obtain metal salts solution. The solution was added to the round bottom bottle and stood for 2 hours, whereby the metal salts were adsorbed on 20 wt % Nd₂O₃-alumina porous support. The mixture in the round bottom bottle was heated to 110° C. and vacuumed to remove the water thereof to obtain a dried powder, Pd_{0.3}/20 wt % Nd₂O₃-alumina catalyst.

### Preparation Example 9

2.524 g of La(NO₃)₃ was dissolved in water to obtain an aqueous solution. The aqueous solution and 7.92 g of Al₂O₃ (SD alumina) were added to a round bottom bottle and stirred. The mixture in the round bottom bottle was heated to 110° C. and vacuumed to remove water, and then sintered at 600° C. thereof to obtain a dried powder, 20 wt % La₂O₃-alumina. 9.9 g of 20 wt % La₂O₃-alumina serving as a porous support was put into an oven at 110° C. to be dried overnight and then put into a round bottom bottle. 0.213 g of palladium acetate was dissolved in water to obtain metal salts solution. The solution was added to the round bottom bottle and stood for 2 hours, whereby the metal salts were adsorbed on 20 wt % La₂O₃-alumina porous support. The mixture in the round bottom bottle was heated to 110° C. and vacuumed to remove the water thereof to obtain a dried powder, Pd₁/20 wt % La₂O₃-alumina catalyst.

### Preparation Example 10

9.97 g of 20 wt % La₂O₃-alumina serving as a porous support was put into an oven at 110° C. to be dried overnight and then put into a round bottom bottle. 0.063 g of palladium acetate was dissolved in water to obtain metal salts solution. The solution was added to the round bottom bottle and stood for 2 hours, whereby the metal salts were adsorbed on 20 wt % La₂O₃-alumina porous support. The mixture in the round bottom bottle was heated to 110° C. and vacuumed to remove the water thereof to obtain a dried powder, Pd_{0.3}/20 wt % La₂O₃-alumina catalyst.

### Comparative Example 1

9 g of the styrene-isoprene-styrene block copolymer (SIS, Kraton D1161) was dissolved in 111 g of cyclohexane to form a SIS solution (7.5 wt %). The SIS solution was put into a reaction vessel. 1.8 g of the Pt_{3.5}Ir₁/SiO₂ catalyst prepared in Preparation Example 1 was added to the reaction vessel. The reaction vessel was sealed, and hydrogen of 40 kg/cm² was conducted to the reaction vessel. The reaction vessel was heated to 120° C. to process the hydrogenation for 156 mins, and the heating process was then stopped. The conversion ratio of the hydrogenation was measured by FT-IR and UV-VIS spectrometers, as tabulated in Table 1.

### Comparative Example 2

9 g of the styrene-isoprene-styrene block copolymer (SIS, Kraton D1161) was dissolved in 111 g of cyclohexane to form a SIS solution (7.5 wt %). The SIS solution was put into a reaction vessel. 1.8 g of the Pd₂/Al₂O₃ catalyst prepared in Preparation Example 2 was added to the reaction vessel. The reaction vessel was sealed, and hydrogen of 40 kg/cm² was conducted to the reaction vessel. The reaction vessel was heated to 120° C. to process the hydrogenation for 228 mins, and the heating process was then stopped. The conversion ratio of the hydrogenation was measured by FT-IR and UV-VIS spectrometers, as tabulated in Table 1.

### Comparative Example 3

9 g of the styrene-isoprene-styrene block copolymer (SIS, Kraton D1161) was dissolved in 111 g of cyclohexane to form a SIS solution (7.5 wt %). The SIS solution was put into a reaction vessel. 1.8 g of the Pd₂/Al₂O₃ catalyst prepared in Preparation Example 3 was added to the reaction vessel. The reaction vessel was sealed, and hydrogen of 40 kg/cm² was conducted to the reaction vessel. The reaction vessel was heated to 120° C. to process the hydrogenation for 250 mins, and the heating process was then stopped. The conversion ratio of the hydrogenation was measured by FT-IR and UV-VIS spectrometers, as tabulated in Table 1.

### Example 1

9 g of the styrene-isoprene-styrene block copolymer (SIS, Kraton D1161) was dissolved in 111 g of cyclohexane to form a SIS solution (7.5 wt %). The SIS solution was put into a reaction vessel. 1.8 g of the Pd₁/20 wt % Sm₂O₃-alumina catalyst prepared in Preparation Example 4 was added to the reaction vessel. The reaction vessel was sealed, and hydrogen of 40 kg/cm² was conducted to the reaction vessel. The reaction vessel was heated to 80° C. to process the hydrogenation for 41 mins, and the heating process was then stopped. The conversion ratio of the hydrogenation was measured by FT-IR and UV-VIS spectrometers, as tabulated in Table 1.

### Example 2

9 g of the SIS (Kraton D1161) was dissolved in 111 g of cyclohexane to form a SIS solution (7.5 wt %). The SIS solution was put into a reaction vessel. 1.8 g of the Pd_{0.16}/20 wt % Sm₂O₃-alumina catalyst prepared in Preparation Example 5 was added to the reaction vessel. The reaction vessel was sealed, and hydrogen of 40 kg/cm² was conducted to the reaction vessel. The reaction vessel was heated to 80° C. to process the hydrogenation for 41 mins, and the heating process was then stopped. The conversion ratio of the hydrogenation was measured by FT-IR and UV-VIS spectrometers, as tabulated in Table 1.

### Example 3

9 g of the SIS (Kraton D1161) was dissolved in 111 g of cyclohexane to form a SIS solution (7.5 wt %). The SIS solution was put into a reaction vessel. 1.8 g of the Pd_{0.3}/10 wt % Sm₂O₃-alumina catalyst prepared in Preparation Example 6 was added to the reaction vessel. The reaction vessel was sealed, and hydrogen of 40 kg/cm² was conducted to the reaction vessel. The reaction vessel was heated to 80° C. to process the hydrogenation for 41 mins, and the heating process was then stopped. The conversion ratio of the hydrogenation was measured by FT-IR and UV-VIS spectrometers, as tabulated in Table 1.

### Example 4

9 g of the SIS (Kraton D1161) was dissolved in 111 g of cyclohexane to form a SIS solution (7.5 wt %). The SIS solution was put into a reaction vessel. 1.8 g of the Pd₁/5 wt % Sm₂O₃-alumina catalyst prepared in Preparation Example 7 was added to the reaction vessel. The reaction vessel was sealed, and hydrogen of 40 kg/cm² was conducted to the reaction vessel. The reaction vessel was heated to 80° C. to process the hydrogenation for 41 mins, and the heating process was then stopped. The conversion ratio of the hydrogenation was measured by FT-IR and UV-VIS spectrometers, as tabulated in Table 1.

### Example 5

9 g of the SIS (Kraton D1161) was dissolved in 111 g of cyclohexane to form a SIS solution (7.5 wt %). The SIS solution was put into a reaction vessel. 1.8 g of the Pd_{0.3}/20 wt % Nd₂O₃-alumina catalyst prepared in Preparation Example 8 was added to the reaction vessel. The reaction vessel was sealed, and hydrogen of 40 kg/cm² was conducted to the reaction vessel. The reaction vessel was heated to 80° C. to process the hydrogenation for 41 mins, and the heating process was then stopped. The conversion ratio of the hydrogenation was measured by FT-IR and UV-VIS spectrometers, as tabulated in Table 1.

### Example 6

9 g of the SIS (Kraton D1161) was dissolved in 111 g of cyclohexane to form a SIS solution (7.5 wt %). The SIS solution was put into a reaction vessel. 1.8 g of the Pd₁/20 wt % La₂O₃-alumina catalyst prepared in Preparation Example 9 was added to the reaction vessel. The reaction vessel was sealed, and hydrogen of 40 kg/cm² was conducted to the reaction vessel. The reaction vessel was heated to 80° C. to process the hydrogenation for 39 mins, and the heating process was then stopped. The conversion ratio of the hydrogenation was measured by FT-IR and UV-VIS spectrometers, as tabulated in Table 1.

### Example 7

9 g of the SIS (Kraton D1161) was dissolved in 111 g of cyclohexane to form a SIS solution (7.5 wt %). The SIS solution was put into a reaction vessel. 1.8 g of the Pd_{0.3}/20 wt % La₂O₃-alumina catalyst prepared in Preparation Example 10 was added to the reaction vessel. The reaction vessel was sealed, and hydrogen of 40 kg/cm² was conducted to the reaction vessel. The reaction vessel was heated to 80° C. to process the hydrogenation for 37 mins, and the heating process was then stopped. The conversion ratio of the hydrogenation was measured by FT-IR and UV-VIS spectrometers, as tabulated in Table 1.

### Comparative Example 4

9 g of the styrene-butadiene-styrene block copolymer (SBS, Mn=62000) was dissolved in 111 g of cyclohexane to form a SBS solution (7.5 wt %). The SBS solution was put into a reaction vessel. 1.8 g of the Pd₂/Al₂O₃ catalyst prepared in Preparation Example 2 was added to the reaction vessel. The reaction vessel was sealed, and hydrogen of 40 kg/cm² was conducted to the reaction vessel. The reaction vessel was heated to 80° C. to process the hydrogenation for 130 mins, and the heating process was then stopped. The conversion ratio of the hydrogenation was measured by FT-IR and UV-VIS spectrometers, as tabulated in Table 1.Example 8

### Example 8

9 g of the SBS (Mn=62000) was dissolved in 111 g of cyclohexane to form an SBS solution (15 wt %). The SBS solution was put into a reaction vessel. 1.8 g of the Pd_{0.3}/20 wt % La₂O₃-alumina catalyst prepared in Preparation Example 10 was added to the reaction vessel. The reaction vessel was sealed, and hydrogen of 40 kg/cm² was conducted to the reaction vessel. The reaction vessel was heated to 80° C. to process the hydrogenation for 35 mins, and the heating process was then stopped. The conversion ratio of the hydrogenation was measured by FT-IR and UV-VIS spectrometers, as tabulated in Table 1.

TABLE 1

| | | | | | | | Conversion | |
|---|---|---|---|---|---|---|---|---|
| | | pore | | | Hydrogenation | | ratio (%) | |
| | | diameter | Dispersion | | temperature | Hydrogenation | Double | Benzene |
| | Catalyst | (μm) | (%) | Copolymer | (° C.) | period (min) | bond | ring |
| Comparative | Pt_{3.5}Ir₁/SiO₂ | 0.05 | 6.2 | SIS | 120 | 156 | 98 | <2 |
| Example 1 | | | | | | | | |
| Comparative | Pd₂/Al₂O₃ | 1.1 | 16.0 | | | 228 | 92 | <5 |
| Example 2 | | | | | | | | |
| Comparative | Pd₂/Al₂O₃ | 0.01 | 5.3 | | | 250 | 85 | <5 |
| Example 3 | | | | | | | | |
| Example 1 | Pd₁/20 wt % Sm₂O₃- | 1.1 | 48.2 | | 80 | 41 | >98 | <2 |
| | alumina | | | | | | | |
| Example 2 | Pd_{0.16}/20 wt % Sm₂O₃- | 1.1 | 51.2 | | | 41 | >98 | <2 |
| | alumina | | | | | | | |
| Example 3 | Pd_{0.3}/10 wt % Sm₂O₃- | 1.1 | 49.2 | | | 41 | >98 | <2 |
| | alumina | | | | | | | |
| Example 4 | Pd₁/5 wt % Sm₂O₃- | 1.1 | 45.2 | | | 41 | >97 | <2 |
| | alumina | | | | | | | |
| Example 5 | Pd_{0.3}/20 wt % Nd₂O₃- | 1.1 | 47.9 | | | 41 | >98 | <2 |
| | alumina | | | | | | | |
| Example 6 | Pd₁/20 wt % La₂O₃- | 1.1 | 35.1 | | | 39 | >97 | <2 |
| | alumina | | | | | | | |
| Example 7 | Pd_{0.3}/2.0 wt % La₂O₃- | 1.1 | 41.0 | | | 37 | >97 | <2 |
| | alumina | | | | | | | |
| Comparative | Pd2/Al2O3 | 1.1 | 16.0 | SBS | 80 | 130 | >96 | <2 |
| Example 4 | | | | | | | | |
| Example 8 | Pd0.3/20 wt % La2O3- | 1.1 | 41.0 | | | 35 | >98 | <2 |
| | alumina | | | | | | | |

Compared to Comparative Examples 2 and 3, the pore diameter of the porous support is too small, such that it is difficult for the copolymer to enter the porous support to contact the palladium particles, thereby needing a longer hydrogenation period, and the hydrogenation product had a lower nonaromatic carbon-carbon double bond conversion ratio.

It will be apparent to those skilled in the art that various modifications and variations can be made to the disclosed methods and materials. It is intended that the specification and examples be considered as exemplary only, with the true scope of the disclosure being indicated by the following claims and their equivalents.

What is claimed is:

1. A heterogeneous catalyst for selectively hydrogenating a copolymer, comprising:
a porous support,
a metal oxide wrapping a part of the surface of the porous support; and
a plurality of palladium particles on the porous support and the metal oxide.

2. The heterogeneous catalyst as claimed in claim 1, wherein the porous support comprises titanium oxide, aluminum oxide, zirconium oxide, or silicon oxide.

3. The heterogeneous catalyst as claimed in claim 1, wherein the metal oxide comprises samarium oxide (Sm₂O₃), lanthanum oxide (La₂O₃), neodymium oxide (Nd₂O₃) or a combination thereof.

4. The heterogeneous catalyst as claimed in claim 1, wherein the porous support and the metal oxide have a weight ratio of 1:1 to 1:0.025.

5. The heterogeneous catalyst as claimed in claim 1, wherein palladium particles have a range of 0.1 wt % to 5 wt % of the catalyst.

6. A method for selectively hydrogenating a copolymer, comprising:
providing a copolymer including aromatic rings and nonaromatic double bonds,
contacting the copolymer to a heterogeneous catalyst, and introducing hydrogen to selectively hydrogenate the nonaromatic double bonds of the copolymer and substantially not hydrogenate the aromatic rings of the copolymer,
wherein the heterogeneous catalyst comprises a porous support, a metal oxide wrapping a part of the surface of the porous support; and a plurality of palladium particles formed on the porous support and the metal oxide.

7. The method as claimed in claim 6, wherein the porous support has an average pore diameter between 0.02 μm to 1.2 μm.

8. The method as claimed in claim 6, wherein the palladium particles have a diameter between 1 nm to 3 nm.

9. The method as claimed in claim 6, wherein the copolymer is copolymerized of a polyenic monomer and a vinyl aromatic monomer.

10. The method as claimed in claim 9, wherein the polyenic monomer comprises butadiene, isoprene, or a combination thereof.

11. The method as claimed in claim 9, wherein the vinyl aromatic monomer comprises styrene, α-methylstyrene, or a combination thereof.

12. The method as claimed in claim 6, wherein the copolymer has an average molecular weight between 30,000 to 400,000.

13. The method as claimed in claim 6, wherein the porous support comprises titanium oxide, aluminum oxide, zirconium oxide, or silicon oxide.

14. The method as claimed in claim 6, wherein the metal oxide comprises samarium oxide (Sm₂O₃), lanthanum oxide (La₂O₃), neodymium oxide (Nd₂O₃) or a combination thereof.

15. The method as claimed in claim 6, wherein the porous support and the metal oxide have a weight ratio of 1:1 to 1:0.025.

16. The method as claimed in claim 6, wherein palladium particles have a range of 0.1 wt % to 5 wt % of the catalyst.
